(19) United States
(12) Patent Application Publication
(10) Pub. No.: US 2009/0202933 A1
(43) Pub. Date: Aug. 13, 2009

(54) YELLOW TONER

(75) Inventor: Muneharu Ito, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ZEON CORPORATION, Tokyo (JP)

(21) Appl. No.: 12/095,186

(22) PCT Filed: Nov. 27, 2006
(86) PCT No.: PCT/JP2006/324124

§ 371 Date: May 28, 2008

(30) Foreign Application Priority Data
Nov. 28, 2005 (JP) 2005-342952

(51) Int. Cl. G03G 9/09

(52) U.S. Cl. 430/108.23

(57) ABSTRACT

A yellow toner comprising colored resin particles containing a binder resin and a yellow colorant, wherein the yellow colorant is a compound represented by a structural formula (1):

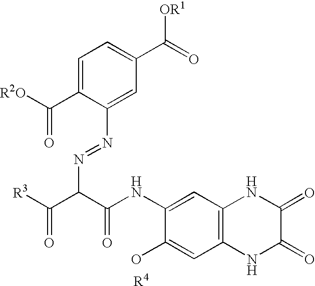

wherein R¹, R², R³ and R⁴ are, independently of one another, a hydrogen atom, an alkyl group having 1 to 12 carbon atoms, or an alkenyl group having 2 to 12 carbon atoms, and the average circularity of the colored resin particles is 0.970 to 0.995.

### TECHNICAL FIELD

The present invention relates to a yellow toner used for developing electrostatic latent images in image forming apparatus of an electrophotographic system, such as copying machines, facsimiles and printers, and image forming apparatus of a toner jet system. More particularly, the present invention relates to a yellow toner which is free of deterioration of image quality by, for example, occurrence of fog even under various temperature and humidity environments from low temperature and low humidity to high temperature and high humidity and excellent in various properties such as weathering resistance (including light resistance) and heat resistance.

### BACKGROUND ART

In an image forming apparatus such as an electrophotographic apparatus or electrostatic recording apparatus, an electrostatic latent image is first formed on an image carrying member (photosensitive member) based on image information inputted. The electrostatic latent image is then developed with a developer (toner) to form a visible image (toner image). This toner image is transferred to any of various transfer media such as paper directly or through an intermediate transfer member. The toner image transferred to the transfer medium is fixed thereto by heating, pressing, heating and pressing, or solvent vapor. A printed image is formed on the transfer medium in such a manner.

In recent years, image forming apparatus capable of full-color printing have been being spread in image forming apparatus of an electrophotographic system, such as copying machines, facsimiles and printers. In full-color printing, a full-color image is generally formed by using respective color toners of yellow, cyan, magenta and black in combination. Toners for full-color printing are required to have excellent weathering resistance and heat resistance in addition to feasibility of forming high-definition and high-quality images.

With the spread of the full-color printing by the electrophotographic system, for example, the case where full-color printed articles are placarded out of doors increases. Toners used in such outdoor placard are required to be markedly excellent in weathering resistance including light resistance.

Among the above-described 4 color toners used in the full-color printing, the weathering resistance of the yellow toner in particular is insufficient. When the full-color printed article is placarded out of doors, or at a place exposed to strong rays such as sunray even in doors, the hue of the printed article is thus changed due to deterioration by light such as color fading at a printed portion by the yellow toner.

For example, C.I. Pigment Yellow 13, 14 and 17 have heretofore been representative of the yellow colorant used in the yellow toner. However, these conventional yellow colorants have been insufficient in weathering resistance and moreover have involved a problem that when they are exposed to a high temperature of 200° C. or higher, thermal decomposition is caused. The thermal decomposition produces harmful substances such as 3,3-dichlorobenzidine that is harmful to the human body and carcinogenic. Therefore, in these yellow colorants, treatments such as pulverization and mixing under high-temperature conditions are restricted. These yellow colorants or yellow toners containing the yellow colorants require taking care to handle them so as not to be exposed to high-temperature conditions in storage, carrying and printing.

Japanese Patent Application Laid-Open No. 5-88411 has proposed a yellow toner for electrophotography containing both a dye classified into Solvent Yellow 21 of Color Index and a pigment classified into C.I. Pigment Yellow 14. The dye classified into Solvent Yellow 21 exhibits a vivid yellow color, but involves a problem on weathering resistance. The invention described in this publication is intended to improve the weathering resistance by combining the specific yellow pigment superior in weathering resistance to the yellow dye with the yellow dye poor in weathering resistance. However, the specific combination of the dye and pigment does not permit obtaining a yellow toner satisfying the level of recent requirements for weathering resistance though a yellow toner improved in weathering resistance compared with the single use of the dye is obtained. In addition, the pigment classified into C.I. Pigment Yellow 14 produces harmful substances such as 3,3-dichlorobenzidine.

Japanese Patent Application Laid-Open No. 6-118715 discloses a yellow toner containing C.I. Pigment Yellow 185. Said C.I. Pigment Yellow 185 does not produce harmful substances such as 3,3-dichlorobenzidine because the pigment contains no chlorine atom. However, an investigation by the present inventors has revealed that a yellow toner containing C.I. Pigment Yellow 185 is insufficient in weathering resistance, and fog is liable to occur under a high-temperature and high-humidity environment (see Comparative Example 3 of the present description).

### DISCLOSURE OF THE INVENTION

It is an object of the present invention to provide a yellow toner excellent in weathering resistance (including light resistance) and heat resistance and free of deterioration of image quality by occurrence of fog even under environments of a wide variety of temperature and humidity from low temperature and low humidity to high temperature and high humidity.

The present inventors have carried out an extensive investigation with a view toward achieving the above-described object. As a result, the present inventors have arrived at a yellow toner composed of colored resin particles containing a binder resin and a yellow colorant, in which the yellow colorant is a compound having a specific chemical structure, and the average circularity of the colored resin particles is 0.970 to 0.995.

The yellow toner according to the present invention is markedly excellent in weathering resistance. A printed and fixed image formed with the yellow toner on copying paper was exposed to light for 600 hours by means of a xenon lamp (output: 0.36 W/m²) under an environment of 42° C. in temperature and 50% in humidity. As a result, an experimental result that lowering of an image density is extremely small was achieved.

Since the yellow colorant used in the present invention and having the specific chemical structure has no chlorine atom in its molecule, the colorant does not produce a carcinogenic substance upon its thermal decomposition under high-temperature conditions.

In addition, by finely dispersing the yellow colorant having the specific chemical structure in the binder resin to control the average circularity of the resulting colored resin particles to 0.970 to 0.995, the yellow toner according to the present invention has features that not only the weathering resistance is excellent, but also the fixing ability, flowability, cleaning ability and the like are excellent, and moreover fog is hard to occur under various temperature and humidity environments from low temperature and low humidity to high temperature and high humidity. The present invention has been completed on the basis of these findings.

According to the present invention, there is thus provided a yellow toner comprising colored resin particles containing a binder resin and a yellow colorant, wherein

the yellow colorant is a compound represented by a structural formula (1):

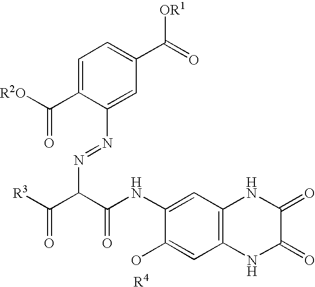

wherein R¹, R², R³ and R⁴ are, independently of one another, a hydrogen atom, an alkyl group having 1 to 12 carbon atoms, or an alkenyl group having 2 to 12 carbon atoms, and the average circularity of the colored resin particles is 0.970 to 0.995.

The yellow toner according to the present invention may preferably be such that the yellow colorant is dispersed in a dispersion condition that when the sections of the colored resin particles are observed through a transmission electron microscope, the average particle diameter of the colorant is at most 80 nm, and the proportion of particles having a particle diameter of at least 400 nm is at most 5% by number.

The yellow colorant used in the present invention may preferably be a compound that R¹, R², R³ and R⁴ in the structural formula (1) are, independently of one another, an alkyl group having 1 to 3 carbon atoms, more preferably a compound that R¹, R², R³ and R⁴ are methyl groups.

The yellow toner according to the present invention may preferably be such that the volume average particle diameter of the colored resin particles is 3 to 8 μm from the viewpoint of forming a high-definition image. In the yellow toner according to the present invention, the average circularity of the colored resin particles is preferably 0.975 to 0.995, more preferably 0.975 to 0.990.

In the present invention, the colored resin particles may preferably be formed by a wet process. The wet process may preferably be a suspension polymerization process.

The colored resin particles may also preferably contain a charge control resin as a charge control agent.

In the present invention, the yellow toner comprises the colored resin particles containing the binder resin and the yellow colorant. The yellow toner according to the present invention may be used as a nonmagnetic one-component developer by adding external additives such as fine silica particles thereto. The yellow toner according to the present invention may be used as a nonmagnetic two-component developer by mixing it with a carrier such as ferrite or iron powder.

### BEST MODE FOR CARRYING OUT THE INVENTION

The yellow toner according to the present invention is composed of colored resin particles containing a binder resin and a yellow colorant. The colored resin particles may contain various kinds of additives such as a charge control agent, a parting agent and a pigment dispersant in the interior thereof as needed. An external additive may be caused to adhere to the external surfaces of the colored resin particles to control the charge property, flowability, shelf stability and the like of the resulting toner.

As examples of the binder resin, may be mentioned resins heretofore widely used in toners, such as polystyrene, styrene-n-butyl acrylate copolymers, polyester resins and epoxy resins. Among these resins, styrene-n-butyl acrylate copolymers are preferred.

In the present invention, a compound of the following structural formula (1) is used as the yellow colorant.

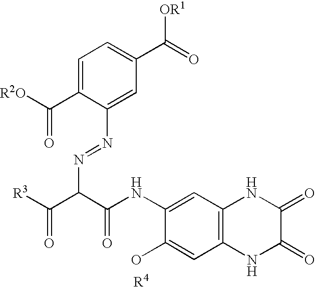

In the structural formula (1), R¹, R², R³ and R⁴ are, independently of one another, a hydrogen atom, an alkyl group having 1 to 12 carbon atoms, or an alkenyl group having 2 to 12 carbon atoms.

R¹, R², R³ and R⁴ are, independently of one another, preferably an alkyl group having 1 to 3 carbon atoms, and all of them are more preferably methyl groups. Specific preferable examples of the compound of the structural formula (1) include C.I. Pigment Yellow 213 that R¹, R², R³ and R⁴ are methyl groups.

In the present invention, as needed, a compound, such as an azo pigment such as another mono-azo pigment than the structural formula (1) or a dis-azo pigment, or a fused polycyclic pigment may be used as the yellow colorant in combination with the compound of the structural formula (1). In this case, the proportion of the compound of the structural formula (1) in the yellow colorant is generally higher than 50% by weight, preferably at least 60% by weight, more preferably at least 70% by weight. The pigment compound used in combination does preferably not contain a chlorine atom in its molecule from the viewpoint of heat resistance.

Specific examples of other pigment compounds than the structural formula (1), which do not contain a chlorine atom, include C.I. Pigment Yellow 65, 74, 120, 151, 155, 180 and 185. Mono-azo pigments such as C.I. Pigment Yellow 65, 74 and 185 are preferred, with C.I. Pigment Yellow 74 being more preferred.

The content of the yellow colorant in the colored resin particles is generally 0.5 to 50 parts by weight, preferably 1 to 15 parts by weight, more preferably 2 to 8 parts by weight per 100 parts by weight of the binder resin. In the case of a polymerized toner described below, 100 parts by weight of the binder resin means 100 parts by weight of a polymerizable monomer.

The yellow toner according to the present invention is preferably such that the yellow colorant is dispersed in a dispersion condition that when the sections of the colored resin particles are observed through a transmission electron microscope, the average particle diameter (hereinafter may be referred to as “dispersion average particle diameter”) of the yellow colorant is at most 80 nm, and the proportion of particles having a particle diameter of at least 400 nm is at most 5% by number. Even when the yellow colorant is a mixture of the compound represented by the structural formula (1) and another compound, such a colorant is preferably in the same dispersion condition as described above.

The dispersion average particle diameter of the yellow colorant in the colored resin particles is more preferably at most 70 nm, particularly preferably at most 50 nm. The proportion of the yellow colorant particles having a particle diameter of at least 400 nm is more preferably at most 4.5%, particularly preferably at most 4.0%.

The dispersion average particle diameter of the yellow colorant in the colored resin particles and the proportion of the particles having a particle diameter of at least 400 nm fall within the above respective ranges, whereby the weathering resistance and environment stability of the resulting toner are more improved.

The dispersion average particle diameter and the proportion (% by number) of the particles having a particle diameter of at least 400 nm, which indicate the dispersion condition of the yellow colorant in the yellow toner, can be determined by a method, in which the sections of the colored resin particles are observed through a transmission electron microscope or the like to obtain an image of 5,000 to 10,000 magnifications, and the measurement is then directly conducted from a photograph taken, or the resultant image is analyzed by an analysis software such as an image processing software (manufactured by Soft Imaging System GmbH; trade name: analySIS FOUR). More specifically, the data of the dispersion average particle diameter and the proportion (% by number) of the particles having a particle diameter of at least 400 nm can be obtained by adopting the measuring method described in Examples of the present description.

The average circularity of the colored resin particles making up the yellow toner according to the present invention is 0.970 to 0.995, preferably 0.975 to 0.995, more preferably 0.975 to 0.990. The average circularity of the colored resin particles falls within the above range, whereby a balance among the flowability, developability and cleaning ability of the resulting yellow toner becomes good.

The circularity of each colored resin particle can be determined according to the following equation:

Circularity=(Peripheral length of a circle equal to the projected area of a particle)/(Peripheral length of a projected image of the particle).

The average circularity can be obtained by calculating out an average value of the circularities of the respective particles. The measuring method of the average circularity is described in detail in Examples.

The volume average particle diameter of the colored resin particles is preferably 3 to 12 μm, more preferably 3 to 9 μm, still more preferably 3 to 8 μm, particularly preferably 5 to 8 μm. The volume average particle diameter of the colored resin particles is small, whereby the resulting toner permits forming a high-definition image. The measuring method of the volume average particle diameter is described in detail in Examples.

As production processes of the colored resin particles according to the present invention, may be adopted a dry process and a wet process, which are generally used as production processes of toners. Examples of the dry process include a pulverization process in which a binder resin and a yellow colorant, and optionally various additives are melted and kneaded, the kneaded product is pulverized, and the pulverized product is classified. Examples of the wet process include a dissolution suspension process, an emulsion polymerization aggregation process, a dispersion polymerization process and a suspension polymerization process.

Among the above processes, the wet process is preferred in the present invention because colored resin particles of micron order can be obtained with a relatively narrow particle diameter distribution, the polymerization processes such as the emulsion polymerization aggregation process, dispersion polymerization process and suspension polymerization process are more preferred, and the suspension polymerization process is particularly preferred.

In the production process of a polymerized toner by the suspension polymerization process, a polymerizable monomer and a colorant, and optionally other additives are first mixed to prepare a polymerizable monomer composition. This polymerizable monomer composition is put into an aqueous medium and then stirred to form droplets (droplets of an oil phase) of the polymerizable monomer composition. A dispersion stabilizer is caused to be contained in the aqueous medium as needed. A polymerization initiator is added into the polymerizable monomer composition or into the aqueous medium during the step of forming the droplets to cause the polymerization initiator to migrate into the droplets. After the droplets of the polymerizable monomer composition is formed in the aqueous medium, the resultant suspension is heated to preferably 35 to 95° C. to conduct polymerization, thereby obtaining an aqueous dispersion containing colored resin particles formed. This aqueous dispersion is washed, dehydrated and dried to obtain colored resin particles. The colored resin particles are classified as needed, an external additive is then added thereto to prepare a one-component developer. The external additive and a carrier may be added to the colored resin particles to prepare a two-component developer.

### 1. Preparation of Polymerizable Monomer Composition

A polymerizable monomer composition contains a polymerizable monomer and a yellow colorant, and various kinds of additives such as a charge control agent, a parting agent, a molecular weight modifier and a dispersion aid may also be caused to be contained as needed. The polymerizable monomer composition is polymerized in the presence of a polymerization initiator, and so the polymerization initiator is caused to be contained before the initiation of polymerization.

In the production process of the yellow toner according to the present invention, a mixed liquid containing the polymerizable monomer and the yellow colorant is preferably fed to a dispersing machine to prepare a polymerizable monomer dispersion with the yellow colorant finely dispersed therein. Specifically, the compound of the structural formula (1) as the yellow colorant, and optionally a part or all (excluding the polymerization initiator) of the other additives are added to the polymerizable monomer, and the mixture is stirred by a high-shear stirrer to evenly and finely disperse the yellow colorant in the polymerizable monomer.

In order to raise dispersion efficiency of the yellow colorant, it is preferable that the mixed liquid of the polymerizable monomer and the yellow colorant is first stirred to prepare a polymerizable monomer dispersion with the yellow colorant finely dispersed therein, and the other additive components are then added to the dispersion.

It is preferable that the mixed liquid containing the polymerizable monomer and the yellow colorant is subjected to preliminary dispersion by means of, for example, a dispersing machine such as an in-line type emulsifying and dispersing machine, and the yellow colorant is then more finely dispersed by a media type dispersing machine.

As the high-shear stirrer for stirring the mixed liquid containing the polymerizable monomer and the yellow colorant, is preferred a media type dispersing machine. The media type dispersing machine is such that a rotor is rotatably arranged within a stator, media particles are filled into a space defined by the stator and the rotor, and the media particles are moved by the rotor rotated. The media type dispersing machine is divided, by the form and how to place of the stator, into types of, for example, horizontal cylinder system, vertical cylinder system and inverse triangle system. Specific examples of the media type dispersing machines include ATTRITOR (manufactured by Mitsui Miike Engineering Corporation, trade name), MIGHTY MILL (manufactured by INOUE MFG., INC., trade name), DIAMOND FINE MILL (manufactured by Mitsubishi Heavy Industries, Ltd., trade name), DYNO-MILL (manufactured by Shinmaru Enterprises Corporation, trade name), PICO MILL (manufactured by Asada Iron Works Co., Ltd., trade name), STAR MILL (manufactured by Ashizawa Finetech Ltd., trade name) and APEX MILL (manufactured by Kotobuki Engineering & Manufacturing Co., Ltd., trade name).

Among the media type dispersing machines, the dispersing machine of the horizontal cylinder system is preferred because influence of gravity is little, and evener dispersion can be achieved. As the media type dispersing machine, a media type dispersing machine having a media-separating screen is more preferred because it has good media-separating ability. As the media type dispersing machine, is still more preferred a media type dispersing machine so constructed that a driving shaft, and a rotor and a media-separating screen, which are arranged on the driving shaft and can be rotated simultaneously in cooperation with the rotation of the driving shaft, are provided within a cylindrical casing, a cylindrical part, in which a plurality of media particle-discharging slits has been formed, is provided at one end of the rotor, the media-separating screen is arranged within the cylindrical part of the rotor, and a liquid introduced into the casing from a liquid inlet is passed through the media-separating screen and discharged out of a liquid outlet, and having a structure that media particles are contained in an internal space defined between the inner surface of the casing and the outer surface of the rotor.

The mixed liquid containing the polymerizable monomer and the yellow colorant is stirred under high shear, whereby the yellow colorant can be finely dispersed in the polymerizable monomer, and in turn colored resin particles, in which the yellow colorant is finely dispersed in a dispersion condition that the average particle diameter of the yellow colorant is at most 80 nm, and the proportion of particles having a particle diameter of at least 400 nm is at most 5% by number, can be obtained.

The other additives are preferably added to the mixed liquid with the yellow colorant finely dispersed in the polymerizable monomer, together with the remaining polymerizable monomer if desired, thereby preparing a polymerizable monomer composition.

In place of the above-described process, the yellow colorant and a part or all (excluding the polymerization initiator) of the other additives may be added to a polymerizable monomer composition to prepare a polymerizable monomer composition with the yellow colorant finely dispersed therein by the media type dispersing machine without conducting the preliminary dispersion. In the above-described process, when a part of the other additives is added, the remaining additive components are added after the dispersion of the yellow colorant. The remaining additive components may be added together with a part of the polymerizable monomer.

### (1) Polymerizable Monomer

In the present invention, a monovinyl monomer is used as a main component of the polymerizable monomer. Examples of the monovinyl monomers include aromatic vinyl monomers such as styrene, vinyltoluene and α-methylstyrene; acrylic acid and methacrylic acid; derivatives of acrylic acid, such as methyl acrylate, ethyl acrylate, propyl acrylate, butyl acrylate, 2-ethylhexyl acrylate, cyclohexyl acrylate, isobonyl acrylate, dimethylaminoethyl acrylate and acrylamide; and derivatives of methacrylic acid, such as methyl methacrylate, ethyl methacrylate, propyl methacrylate, butyl methacrylate, 2-ethylhexyl methacrylate, cyclohexyl methacrylate, isobonyl methacrylate, dimethylaminoethyl methacrylate and methacrylamide.

The monovinyl monomers may be used either singly or in any combination thereof. Among these monovinyl monomers, styrene, styrene derivatives, derivatives of acrylic acid or methacrylic acid, and combinations thereof are preferably used.

The monovinyl monomer(s) is preferably selected in such a manner that the glass transition temperature Tg of a polymer obtained by polymerizing them is 80° C. or lower. The monovinyl monomers are used singly or in combination of 2 or more thereof, whereby the Tg of the polymer formed can be controlled within a desired range.

When a crosslinkable monomer is used together with the monovinyl monomer, the hot offset resistance of the resulting yellow toner can be improved. The crosslinkable monomer means a monomer having at least two polymerizable functional groups. As examples of the crosslinkable monomer, may be mentioned aromatic divinyl compounds such as divinylbenzene, divinylnaphthalene and derivatives thereof; unsaturated carboxylic acid polyesters of polyhydric alcohols, such as ethylene glycol dimethacrylate and diethylene glycol dimethacrylate; divinyl compounds such as N,N-divinylaniline and divinyl ether; and compounds having three or more vinyl groups. These crosslinkable monomers may be used either singly or in any combination thereof.

The crosslinkable monomer is used in a proportion of generally at most 10 parts by weight, preferably 0.01 to 7 parts by weight, more preferably 0.05 to 5 parts by weight, particularly preferably 0.1 to 3 parts by weight per 100 parts by weight of the monovinyl monomer.

It is preferable to use a macromonomer together with the monovinyl monomer because a balance between the high-temperature shelf stability and the low-temperature fixing ability in the resulting yellow toner can be improved. The macromonomer is a macromolecule having a polymerizable carbon-carbon unsaturated double bond at its molecular chain terminal and is generally an oligomer or polymer having a number average molecular weight of 1,000 to 30,000. When the number average molecular weight falls within the above range, the fixing ability and shelf stability of the resulting polymerized toner can be retained without impairing the melt properties of the macromonomer. It is hence preferable that the number average molecular weight be within the above range.

As examples of the polymerizable carbon-carbon unsaturated double bond located at its molecular chain terminal, may be mentioned acryloyl and methacryloyl groups. Among these, the methacryloyl group is preferred from the viewpoint of easiness of copolymerization. The macromonomer is preferably that giving a polymer having a glass transition temperature higher than that of a polymer obtained by polymerizing the monovinyl monomer.

As examples of the macromonomer, may be mentioned polymers obtained by polymerizing styrene, styrene derivatives, methacrylic esters, acrylic esters, acrylonitrile and methacrylonitrile either singly or in combination of two or more monomers thereof; and macromonomers having a polysiloxane skeleton. Among these, hydrophilic macromonomers, in particular, polymers obtained by polymerizing methacrylic esters or acrylic esters either singly or in combination thereof are preferred.

When the macromonomer is used, the amount of the macromonomer used is within a range of generally 0.01 to 10 parts by weight, preferably 0.03 to 5 parts by weight, more preferably 0.05 to 1 part by weight per 100 parts by weight of the monovinyl monomer. The macromonomer is preferably used in the amount within the above range because the shelf stability of the resulting yellow toner is retained, and the fixing ability thereof is improved.

### (2) Pigment Dispersant

In order to stabilize the dispersion condition of the yellow colorant in the polymerizable monomer composition, it is preferable in the present invention to add a pigment dispersant. As the pigment dispersant, is preferred a coupling agent such as an aluminum coupling agent, silane coupling agent or titanium coupling agent. The pigment dispersant is preferably added before the polymerizable monomer composition is charged into the high-shear stirrer. The pigment dispersant is used in a proportion of preferably 0.01 to 10 parts by weight, more preferably 0.05 to 5 parts by weight, still more preferably 0.1 to 1 part by weight per 100 parts by weight of the monovinyl monomer.

### (3) Charge Control Agent

In the present invention, a charge control agent is preferably added into the polymerizable monomer composition for the purpose of improving the charge property of the resulting yellow toner. The charge control agent can be divided into a charge control agent having positively charging ability and a charge control agent having negatively charging ability. Example of the charge control agent having positively charging ability include nigrosine dyes, quaternary ammonium salts, triaminotriphenylmethane compounds, imidazole compounds and polyamine resins. As charge control agents having positively charging ability, may also be used charge control resins such as quaternary ammonium group-containing copolymers (including those in which the quaternary ammonium group forms a salt with a metal).

Example of the charge control agent having negatively charging ability include azo dyes containing a metal such as Cr, Co, Al or Fe, salicylic acid metal compounds and alkylsalicylic acid metal compounds. As charge control agents having negatively charging ability, may also be used charge control resins such as sulfonic (salt) group-containing copolymers (including those in which the carboxyl group forms a salt with a metal) and carboxyl group-containing copolymers (including those in which the carboxyl group forms a salt with a metal).

Among these charge control agents, the charge control resins are preferred because the resistance to printing of the resulting yellow toner is improved.

The weight average molecular weight of the charge control resin is within a range of generally 2,000 to 30,000, preferably 4,000 to 25,000, more preferably 6,000 to 20,000.

The charge control agent is used in a proportion of generally 0.01 to 10 parts by weight, preferably 0.1 to 10 parts by weight per 100 parts by weight of the polymerizable monomer.

### (4) Molecular Weight Modifier

Upon the polymerization, a molecular weight modifier is preferably used. Examples of the molecular weight modifier include mercaptans such as t-dodecylmercaptan, n-dodecylmercaptan, n-octylmercaptan and 2,2,4,6,6-pentamethylheptane-4-thiol; and halogenated hydrocarbons such as carbon tetrachloride and carbon tetrabromide. The amount of the molecular weight modifier added is preferably 0.01 to 10 parts by weight, more preferably 0.1 to 5 parts by weight per 100 parts by weight of the monovinyl monomer.

### (5) Parting Agent

In order to improve the parting ability of the resulting yellow toner from a fixing roll upon fixing, a parting agent is preferably added. No particular limitation is imposed on the parting agent so far as it is generally used as a parting agent for toners.

Specific examples of the parting agent include low molecular weight polyolefin waxes, natural waxes, petroleum waxes, mineral waxes, synthetic waxes and ester compounds. Among these, ester compounds are preferred, and polyhydric alcohol ester compounds, such as pentaerythritol esters such as pentaerythritol tetramyristate, pentaerythritol tetrapalmitate, pentaerythritol tetrastearate and pentaerythritol tetralaurate; and dipentaerythritol esters such as dipentaerythritol hexamyristate, dipentaerythritol hexapalmitate and dipentaerythritol hexylaurate are more preferred. These parting agents may be used either singly or in any combination thereof. The proportion of the parting agent is preferably 0.5 to 30 parts by weight, more preferably 1 to 10 parts by weight per 100 parts by weight of the monovinyl monomer.

### (6) Polymerization Initiator

As examples of the polymerization initiator for the polymerizable monomer, may be mentioned persulfates such as potassium persulfate and ammonium persulfate; azo compounds such as 4,4′-azobis(4-cyanovaleric acid), 2,2′-azobis[2-methyl-N-(2-hydroxyethyl)propionamide], 2,2′-azobis(2-amidinopropane) dihydrochloride, 2,2′-azobis(2,4-dimethylvaleronitrile) and 2,2′-azobisisobutyronitrile; and peroxides such as di-t-butyl peroxide, dicumyl peroxide, lauroyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, 1,1′,3,3′-tetramethylbutyl peroxy-2-ethylhexanoate and t-butyl peroxyisobutyrate. Redox initiators obtained by combining these polymerization initiators with a reducing agent may also be used.

Among these polymerization initiators, an oil-soluble polymerization initiator, which is soluble in the polymerizable monomer, is preferably selected, and a water-soluble polymerization initiator may also be used in combination with the oil-soluble initiator as needed.

The polymerization initiator is used in a proportion of generally 0.1 to 20 parts by weight, preferably 0.3 to 15 parts by weight, more preferably 0.5 to 10 parts by weight per 100 parts by weight of the polymerizable monomer.

The polymerization initiator may be added into the polymerizable monomer composition in advance. In order to avoid premature polymerization, however, the polymerization initiator is preferably added directly into the suspension in the middle or after completion of the step of forming droplets of the polymerizable monomer composition, or in the middle of a polymerization reaction.

### 2. Formation of Droplets of Polymerizable Monomer Composition

In the present invention, the polymerizable monomer composition prepared in the above-described manner is dispersed in an aqueous medium, to form droplets of the polymerizable monomer composition. The formation of the droplets is conducted by means of a device capable of strongly stirring, such as an in-line type emulsifying and dispersing machine (manufactured by Ebara Corporation, trade name “MILDER”) or a high-speed emulsifying and dispersing machine (manufactured by Tokushu Kika Kogyo Co., Ltd., trade name “T.K. HOMO MIXER MARK II”).

The aqueous medium may be water alone. However, a solvent soluble in water, such as a lower alcohol or lower ketone, may also be used in combination with water. A dispersion stabilizer is preferably caused to be contained in the aqueous medium.

As examples of the dispersion stabilizers, may be mentioned metallic compounds, such as sulfates such as barium sulfate and calcium sulfate; carbonates such as barium carbonate, calcium carbonate and magnesium carbonate; phosphates such as calcium phosphate; metal oxides such as aluminum oxide and titanium oxide; and metal hydroxides such as aluminum hydroxide, magnesium hydroxide and ferric hydroxide. An organic compound, such as a water-soluble polymer such as polyvinyl alcohol, methyl cellulose or gelatin; an anionic surfactant, a nonionic surfactant; or an amphoteric surfactant, may also be used as the dispersion stabilizer.

Among these dispersion stabilizers, a dispersion stabilizer composed of colloid of a metallic compound, particularly, a hardly water-soluble metal hydroxide is preferred because the particle diameter distribution of the resulting colored resin particles (yellow toner) can be narrowed, and the amount of the dispersion stabilizer remaining after washing becomes little, so that environmental stability is also good, and a bright image can be obtained.

In general, the polymerizable monomer composition is dispersed in the aqueous medium containing the dispersion stabilizer to form uniform droplets of the polymerizable monomer composition. In the formation of the droplets of the polymerizable monomer composition, primary droplets having a volume average droplet diameter of about 50 to 1,000 μm are first formed. In order to avoid premature polymerization, the polymerization initiator is preferably added to the aqueous dispersion medium after the size of the droplets in the aqueous medium becomes uniform.

The polymerization initiator is added and mixed into the suspension with the primary droplets of the polymerizable monomer composition dispersed in the aqueous dispersion medium, and the resultant mixture is stirred by means of a high-speed rotating and shearing type stirrer until the droplet diameter of the droplets becomes a small diameter near to the intended particle diameter of the colored resin particles (colored polymer particles). In such a manner, secondary droplets generally having a fine volume average droplet diameter of about 3 to 12 μm are formed.

### 3. Suspension Polymerization

After the formation of the droplets of the polymerizable monomer composition, the aqueous medium is heated to initiate polymerization, thereby obtaining an aqueous dispersion of colored resin particles. Specifically, a polymerization reactor is charged with a suspension containing secondary droplets of the polymerizable monomer composition to conduct suspension polymerization at a temperature of generally 5 to 120° C., preferably 35 to 95° C., more preferably 50 to 95° C.

In order to lower the fixing temperature of the resulting yellow toner, it is preferable to select a polymerizable monomer or a combination of polymerizable monomers, which permits forming a polymer having a glass transition temperature Tg of the order of generally 80° C. or lower, preferably 40 to 80° C., more preferably 50 to 70° C. In the present invention, the Tg of the polymer making up the binder resin is a calculated value calculated out according to the kind(s) and proportion(s) of the polymerizable monomer(s) used.

The suspension polymerization forms colored resin particles (colored polymer particles; polymerized toner) with the additive components containing the yellow colorant dispersed in the polymer of the polymerizable monomer. In the present invention, the colored resin particles are used as a yellow toner. In order to improve the shelf stability (blocking resistance), low-temperature fixing ability and melting ability upon fixing of the resulting yellow toner, an additional polymer layer may be formed on the colored resin particles obtained by the suspension polymerization to provide core-shell type colored resin particles.

No particular limitation is imposed on a process for producing the colored resin particles of the core-shell type, and conventionally known production processes such as an in-situ polymerization process and a phase separation process may be adopted.

As a process for forming the core-shell type structure, is preferably adopted, for example, a process (in-situ polymerization process), in which the above-described colored resin particles are used as core particles, and a polymerizable monomer for shell is polymerized in the presence of the core particles to form a polymer layer (shell) on each surface of the core particles.

When a monomer forming a polymer having a Tg higher than the Tg of the polymer component forming the core particles is used as the polymerizable monomer for shell, the shelf stability of the resulting polymerized toner can be improved. On the other hand, the Tg of the polymer component forming the core particles is preset low, thereby permitting lowering the fixing temperature of the resulting polymerized toner and improving the melting properties thereof. Accordingly, the colored resin particles of the core-shell structure are formed in the polymerization step, thereby providing a polymerized toner capable of meeting speeding-up of printing, formation of full-color images and permeability through an overhead projector (OHP).

As polymerizable monomers for forming the core and shell, respective preferable monomers may be suitably selected from among the above-mentioned monovinyl monomers. A weight ratio of the polymerizable monomer for core to the polymerizable monomer for shell is generally 40/60 to 99.9/0.1, preferably 60/40 to 99.7/0.3, more preferably 80/20 to 99.5/0.5. If the proportion of the polymerizable monomer for shell is too low, the effect of improving the shelf stability of the resulting polymerized toner becomes little. If the proportion is too high on the other hand, the effect of lowering the fixing temperature of the resulting polymerized toner becomes little.

The Tg of the polymer formed from the polymerizable monomer for shell is generally higher than 50° C., but not higher than 120° C., preferably higher than 60° C., but not higher than 110° C., more preferably higher than 80° C., but not higher than 105° C. A difference in Tg between the polymer formed from the polymerizable monomer for core and the polymer formed from the polymerizable monomer for shell is preferably at least 10° C., more preferably at least 20° C., particularly preferably at least 30° C. In many cases, a monomer capable of forming a polymer having a Tg of generally 60° C. or lower, preferably 40 to 60° C. is preferably selected as the polymerizable monomer for core from the viewpoint of a balance between fixing temperature and shelf stability. On the other hand, as the polymerizable monomer for shell, monomers capable of forming a polymer having a Tg higher than 80° C., such as styrene and methyl methacrylate, may be preferably used either singly or in combination of two or more monomers thereof.

The polymerizable monomer for shell is preferably added to the polymerization reaction system as droplets having a droplet diameter smaller than the average particle diameter of the core particles. If the droplet diameter of the droplets of the polymerizable monomer for shell is too great, it is difficult to uniformly form the polymer layer about the core particles. In order to form the polymerizable monomer for shell into fine droplets, it is only necessary to subject a mixture of the polymerizable monomer for shell and an aqueous dispersion medium to a finely dispersing treatment by means of, for example, an ultrasonic emulsifier and add the resultant dispersion to the polymerization reaction system.

When the polymerizable monomer for shell is a relatively water-soluble monomer (for example, methyl methacrylate) having a solubility of at least 0.1% by weight in water at 20° C., the monomer tends to relatively quickly migrate into the surfaces of the core particles, so that there is no need to conduct the finely dispersing treatment. However, it is preferable to conduct the finely dispersing treatment from the viewpoint of forming a uniform shell. On the other hand, when the polymerizable monomer for shell is a monomer (for example, styrene) having a solubility lower than 0.1% by weight in water at 20° C., it is preferable that the monomer be made liable to migrate into the surfaces of the core particles by conducting the finely dispersing treatment or adding an organic solvent (for example, an alcohol) having a solubility of at least 5% by weight in water at 20° C. to the reaction system.

A charge control agent may be added to the polymerizable monomer for shell if desired. As the charge control agent, may preferably be used the same charge control agent as described above. When the charge control agent is used, it is used in a proportion of generally 0.01 to 10 parts by weight, preferably 0.1 to 5 parts by weight per 100 parts by weight of the polymerizable monomer for shell.

In order to produce the colored resin particles of the core-shell structure, the polymerizable monomer for shell or an aqueous dispersion thereof is added to the suspension containing the core particles in one lot, or continuously or intermittently. It is preferable from the viewpoint of efficiently forming the shell to add a water-soluble radical initiator at the time the polymerizable monomer for shell is added. It is considered that when the water-soluble polymerization initiator is added upon the addition of the polymerizable monomer for shell, the water-soluble polymerization initiator enters in the vicinity of each outer surface of the core particles to which the polymerizable monomer for shell has migrated, so that a polymer layer is easy to be formed on the surfaces of the core particles.

As examples of the water-soluble polymerization initiator, may be mentioned persulfates such as potassium persulfate and ammonium persulfate; and azo initiators such as 2,2′-azobis[2-methyl-N-(2-hydroxyethyl)propionamide] and 2,2′-azobis-[2-methyl-N-[1,1-bis(hydroxymethyl)ethyl]-propionamide. The proportion of the water-soluble polymerization initiator used is generally 0.1 to 50 parts by weight, preferably 1 to 20 parts by weight per 100 parts by weight of the polymerizable monomer for shell.

The average thickness of the shell is generally 0.001 to 1.0 μm, preferably 0.003 to 0.5 μm, more preferably 0.005 to 0.2 μm. If the thickness of the shell is too great, the fixing ability of the resulting polymerized toner is deteriorated. If the thickness is too small, the shelf stability of the resulting polymerized toner is deteriorated.

The particle diameters of the core particles and the thickness of the shell in the polymerized toner can be determined by directly measuring the size and shell thickness of each of particles selected at random from electron photomicrographs thereof when they can be observed through an electron microscope. If the core and shell in each particle are difficult to be observed through the electron microscope, the thickness of the shell can be calculated out from the particle diameter of the core particle and the amount of the polymerizable monomer used for forming the shell.

### 4. Post Treatment Step

The aqueous dispersion containing the colored resin particles obtained by the polymerization is subjected to treatments such as filtration, removal of the dispersion stabilizer, dehydration and drying, whereby dry colored resin particles are recovered.

When an inorganic compound such as an inorganic hydroxide is used as the dispersion stabilizer, it is preferable as a washing method to add an acid or alkali to the aqueous dispersion containing the colored resin particles, thereby dissolving the dispersion stabilizer in water to remove it. When colloid of a hardly water-soluble inorganic hydroxide is used as the dispersion stabilizer, an acid is added to the aqueous dispersion of the colored resin particles to adjust the pH of the aqueous dispersion to 6.5 or lower, thereby conducting acid washing. As the acid, may be used an inorganic acid such as sulfuring acid, hydrochloric acid or nitric acid; or an organic acid such as formic acid or acetic acid. However, sulfuric acid is particularly preferred because of high removal efficiency and small burden on production facilities.

The colored resin particles are obtained by the above-described polymerization process, and the colored resin particles make up the yellow toner according to the present invention.

### 5. Pulverization Process

When color particles are produced in accordance with the pulverization process, the production is conducted by the following process. First, a binder resin, a yellow colorant and optional other additives such as a parting agent and charge control agent are mixed by means of a ball mill, V-type mixer, Henschel mixer, high-speed dissolver, internal mixer, screw-type extruder, fall berg or the like.

The resultant mixture is then melt-kneaded by means of a pressure kneader, twin-screw extrusion kneader, roller or the like while heating. After cooling the melt-kneaded product, the cooled product was roughly pulverized by means of a pulverizer such as a hammer mill, jet mill, cutter mill or roll mill. The roughly pulverized product is further finely pulverized by means of a pulverizer such as a jet mill or high-speed rotating type pulverizer and then classified into a desired particle diameter by a classifier such as an air classifier or airborne classifier to obtain colored resin particles.

The yellow colorant, parting agent, charge control agent and the like used in the pulverization process may be the same as those used in the polymerization process. The amounts of these additive components added are the same parts by weight as in the polymerization process except that the basis is changed from 100 parts by weight of the vinyl monomer to 100 parts by weight of the binder resin.

The colored resin particles obtained by the pulverization process can be provided as colored resin particles of a core-shell type structure according to the process such as the in-situ polymerization process like the colored resin particles obtained by the polymerization process.

### 6. Colored Resin Particles (Yellow Toner)

The volume average particle diameter Dv of the colored resin particles is preferably 3 to 12 μm, more preferably 3 to 9 μm, still more preferably 3 to 8 μm, particularly preferably 5 to 8 μm. If the volume average particle diameter of the colored resin particles is too small, the flowability of the resulting yellow toner is lowered, and so its transferability may be lowered, blur may occur, or the image density may be lowered in some cases. If the volume average particle diameter of the colored resin particles is too great, the resolution of an image formed with such a toner may be deteriorated in some cases.

In the colored resin particles making up the yellow toner according to the present, the particle diameter distribution Dv/Dp represented by a ratio of the volume average particle diameter Dv to the number average particle diameter Dp is preferably 1.1 to 1.3, more preferably 1.15 to 1.25. If the Dv/Dp is too high, the resulting yellow toner may tend to cause blur or lower transferability, image density and resolution. The volume average particle diameter and number average particle diameter of the colored resin particles can be measured by means of a particle size distribution meter (manufactured by Beckmann Coulter Co.; trade name: MULTISIZER).

The average circularity of the colored resin particles making up the yellow toner according to the present invention is 0.970 to 0.995, preferably 0.975 to 0.995, more preferably 0.975 to 0.990. The average circularity of the colored resin particles falls within this range, whereby the various particles, such as flowability, developability and cleaning ability, of the resulting yellow toner are balanced at a high level.

The yellow toner according to the present invention is preferably such that the yellow colorant is dispersed in a dispersion condition that when the sections of the colored resin particles are observed through a transmission electron microscope, the average particle diameter of the yellow colorant is at most 80 nm, and the proportion of particles having a particle diameter of at least 400 nm is at most 5% by number.

The colored resin particles may be used as a nonmagnetic one-component developer as they are, or by mixing (externally adding) an external additive by means of a high-speed stirrer such as a Henschel mixer. The colored resin particles may also be provided as a nonmagnetic two-component developer by mixing them with a carrier particles such as ferrite or iron powder.

An external additive is preferably mixed with the yellow toner according to the present invention because the charge property, flowability, shelf stability, abrasiveness and the like thereof can be adjusted.

Examples of the external additive include inorganic fine particles such as silica, titanium oxide, aluminum oxide, zinc oxide, tin oxide, calcium carbonate, calcium phosphate and cerium oxide; and organic resin particles such as particles of methacrylic ester polymers, acrylic ester polymers, styrene-methacrylic ester copolymers, styrene-acrylic ester copolymers and melamine resins, and core-shell type particles in which the core is formed by a styrene polymer, and the shell is formed by a methacrylic ester polymer. Among these, silica is preferred.

The external additives such as silica preferably have an average primary particle diameter of 5 to 20 nm, and an external additive having an average primary particle diameter of greater than 20 nm, but not greater than 50 nm is more preferably used in combination with this external additive.

The amount of the external additive added is preferably 0.1 to 6 parts by weight, more preferably 0.2 to 5.0 parts by weight per 100 parts by weight of the colored resin particles.

### EXAMPLES

The present invention will hereinafter be described in more detail by the following examples. However, the present invention is not limited to the following examples alone. All designations of “part” or “parts” and “%” mean part or parts by weight and % by weight unless expressly noted.

Testing methods on various properties adopted in the present invention are as follows.

### (1) Average Circularity

A glass beaker was charged with 10 ml of ion-exchanged water and 0.1 ml of an aqueous solution of alkylbenzenesulfonic acid (product of Fuji Photo Film Co., Ltd.; trade name: DRYWELL) as a dispersant in advance, and 0.1 g of colored resin particles were added thereto to conduct a dispersing treatment for 3 minutes at 60 W by means of an ultrasonic dispersing machine. The concentration of the colored resin particles upon measurement was adjusted to 3,000 to 10,000 particles/μL to measure a circularity as to 1,000 to 10,000 colored resin particles corresponding to circles having a diameter of 1 μm or greater by means of a flow particle image analyzer (manufactured by SYSMEX CORPORATION; trade name “FPIA-2100”). An average circularity was found from the measured values of the circularities of the respective colored resin particles. The circularity is represented by the following equation, and the average circularity is an arithmetic mean of the circularities.

Circularity=(Peripheral length of a circle equal to the projected area of a particle)/(Peripheral length of the projected area of the particle)

### (2) Volume Average Particle Diameter, Number Average Particle Diameter and Particle Diameter Distribution of Colored Resin Particles

The volume average particle diameter Dv, number average particle diameter Dp and particle diameter distribution Dv/Dp of colored resin particles were measured by means of a particle diameter measuring device (manufactured by Beckmann Coulter Co.; trade name “MULTISIZER”). The measurement by this MULTISIZER was conducted under the following conditions:
aperture diameter: 100 μm;
medium: Isothone II, concentration: 10%; and

the number of particles measured: 100,000 particles.

Specifically, 0.1 g of colored resin particles were placed in a beaker, and 0.1 ml of an aqueous solution of alkylbenzenesulfonic acid (product of Fuji Photo Film Co., Ltd.; trade name: DRYWELL) as a dispersant was added. After 0.5 to 2 ml of Isothone II was further added to the beaker to wet the colored resin particles, 10 to 30 ml of Isothone II was additionally added to disperse the colored resin particles for 1 to 3 minutes by means of an ultrasonic dispersing device, followed by the measurement by the particle diameter measuring device.

### (3) Dispersion Condition of Colorant

Sections of colored resin particles were observed through a transmission electron microscope (manufactured by JEOL Ltd.; trade name “JEM-2100”) at 6,000 magnifications to obtain an image of colorant particles in each section. With respect to the image obtained in such a manner, image analysis was conducted (image analysis conditions: luminance 80, contrast 36, cutting 20 nm or less in one pixel) by means of an image processing software (manufactured by Soft Imaging System GmbH; trade name “analySIS FOUR”) to calculate out an arithmetic mean of particle diameter of 300 colorant particles extracted at random as a dispersion average particle diameter and at the same time calculate out % by number of colorant particles having a particle diameter of at least 400 nm.

### (4) Test of Weathering Resistance

A yellow toner was charged into a commercially available printer of a nonmagnetic one-component development system to print a 50 mm square solid image on copying paper. An image density of a fixed image of the thus obtained square solid print was measured by means of a reflection densitometer (manufactured by McBeth Co; model name “RD918”) This image density was regarded as an initial image density (Initial ID).

This solid-printed and fixed image was exposed to light for 600 hours by means of a xenon lamp (output: 0.36 W/m²) under an environment of 42° C. in temperature and 50% in humidity. With respect to the solid-printed and fixed image after the exposure to light, an image density was likewise measured by the reflection densitometer. This image density was regarded as an image density (after-test ID) after the test of weathering resistance.

A percent reduction (%) of image density was calculated from the initial ID value and the after-test ID value.

### (5) Environmental Stability (Fog)

A yellow toner was charged into a commercially available printer of a nonmagnetic one-component development system and left to stand for a day under an environment (N/N environment) of 23° C. in temperature and 50% in humidity. Thereafter, white solid printing was conducted, the printer was stopped in the middle of the printing, and a toner remaining in a non-image area on a photosensitive member after development was applied to a pressure-sensitive adhesive tape (product of Sumitomo 3M Limited, trade name “SCOTCH MENDING TAPE 810-3-18”). This pressure-sensitive tape was stuck on new paper for printing to measure a color tone by means of a spectroscopic color-difference meter (manufactured by Nippon Denshoku K.K., trade name “SE-2000”). An unused pressure-sensitive adhesive tape was stuck as a reference on the paper for printing to measure a color tone likewise. Their color tones were represented as coordinates of the L*a*b* color space to calculate out a color difference ΔE from the color tones of the measured sample and reference sample to find a fog value. The smaller fog value indicates that fog is less, and image quality is better.

### Example 1

A mixture of 70 parts by weight of styrene, 20 parts by weight of butyl acrylate and 6 parts of C.I. Pigment Yellow 213 [a compound that R¹, R², R³ and R⁴ in the structural formula (1) are methyl groups; product of Clariant Japan K.K.; trade name “HOSTAPERM YELLOW H5G”] as a yellow colorant was stirred to prepare a liquid polymerizable monomer mixture. This liquid polymerizable monomer mixture was subjected to preliminary dispersion by an in-line type emulsifying and dispersing machine (manufactured by Ebara Corporation, trade name “MILDER”) to obtain a preliminarily dispersed liquid polymerizable monomer mixture.

The preliminarily dispersed liquid polymerizable monomer mixture by the preliminary dispersion was then stirred by a media type dispersing machine having a media-separating screen (media particles: zirconia bead having a diameter of 0.3 mm; peripheral speed of a driving shaft peripheral speed of a leading end of a rotor: 10 m/sec) to further disperse the yellow colorant.

To 96 parts of the above-described mixture with the yellow colorant finely dispersed therein, were added 10 parts of styrene, 3 parts of a negatively charging charge control resin (sulfonic functional group-containing styrene/acrylic resin, product of Fujikura Kasei Co., Ltd., trade name “FCA-S748”), 0.1 part of a polymethacrylic ester macromonomer (product of Toagosei Chemical Industry Co., Ltd., trade name “AA6”), 0.3 part of an aluminum coupling agent (alkylacetoacetate aluminum diisopropylate; product of Ajinomoto-Fine-Techno Co., Inc., trade name “AL-M”) as a pigment dispersant, 10 parts of dipentaerythritol hexamyristate as a parting agent, 1.5 parts of t-dodecylmercaptan as a molecular weight modifier and 0.5 part of divinylbenzene as a crosslinkable monomer, and the contents were stirred into a solution to prepare a polymerizable monomer composition.

On the other hand, an aqueous solution with 9.3 parts of sodium hydroxide dissolved in 50 parts of ion-exchanged water was gradually added to an aqueous solution with 16.7 parts of magnesium chloride dissolved in 250 parts of ion-exchanged water with stirring to prepare a colloidal dispersion of magnesium hydroxide.

After the above-prepared polymerizable monomer composition was placed into the above-obtained colloidal dispersion of magnesium hydroxide to stir the resultant mixture, 5 parts of t-butyl peroxy-2-ethylhexanoate (product of Nippon Oil & Fats Co., Ltd., trade name “PERBUTYL O”) as a polymerization initiator was poured at the time droplets became stable. The resultant mixture was stirred under high shearing for 10 minutes at a rotating speed of 15,000 rpm by means of an in-line type emulsifying and dispersing machine (manufactured by Ebara Corporation, trade name “MILDER”) to form fine droplets of the polymerizable monomer composition.

The dispersion with the droplets of the polymerizable monomer composition (polymerizable monomer composition for core) dispersed therein was poured into a reactor equipped with an agitating blade and heated to 90° C. to conduct a polymerization reaction. After a conversion into a polymer reached almost 100%, 1 part of methyl methacrylate as a polymerizable monomer for shell and 0.1 part of 2,2′-azobis{2-methyl-N-[1,1-bis(hydroxymethyl)-2-hydroxyethyl]-propionamide} (product of Wako Pure Chemical Industries, Ltd., trade name “VA086”) dissolved in 10 parts of ion-exchanged water were added to continue the reaction for additionally 3 hours while keeping the temperature at 90° C. Thereafter, the reaction mixture was cooled with water to obtain a dispersion of colored resin particles having a core-shell structure. The pH of the dispersion was 9.5.

While stirring the above-obtained dispersion of the colored resin particles, sulfuric acid was added until the pH of the dispersion reached 6 or lower to conduct neutralization. After water was separated from the neutralized dispersion by filtration, 500 parts of ion-exchanged water was newly added to form a slurry again, and the slurry was washed with water. Thereafter, the dehydration and water washing were repeated several times, and solids were then separated by filtration. The solids were then dried at 40° C. for 2 days by a dryer to obtain dry colored resin particles having a volume average particle diameter Dv of 7.4 μm, a particle diameter distribution Dv/Dp of 1.20 and an average circularity of 0.980.

Into 100 parts of the colored resin particles thus obtained, were added 0.5 part of silica having a number average primary particle diameter of 12 nm and 2.0 parts of silica having a number average primary particle diameter of 40 nm, and the resultant mixture was mixed for 10 minutes at a rotating speed of 1,400 rpm by means of a Henschel mixer to prepare a non-magnetic one-component developer (may also be referred to as “toner”).

### Example 2

Eighty parts of styrene, 20 parts of n-butyl acrylate, 6 parts of C.I. Pigment Yellow 213 [a compound that R¹, R², R³ and R⁴ in the structural formula (1) are methyl groups; product of Clariant Japan K.K.; trade name “HOSTAPERM YELLOW H5G”], 3 parts of a negatively charging charge control resin (sulfonic functional group-containing styrene/acrylic resin, product of Fujikura Kasei Co., Ltd., trade name “FCA-S748”) as a charge control agent, 0.5 part of divinylbenzene, 1.5 parts of t-dodecylmercaptan and 10 parts of dipentaerythritol hexamyristate were dispersed by means of a media type dispersing machine (manufactured by TURBO KOGYO CO., LTD., trade name “OB BEAD MILL”) to obtain a polymerizable monomer composition for core.

On the other hand, an aqueous solution with 8.6 parts of sodium hydroxide dissolved in 50 parts of ion-exchanged water was gradually added to an aqueous solution with 15.4 parts of magnesium chloride dissolved in 250 parts of ion-exchanged water with stirring to prepare a colloidal dispersion of magnesium hydroxide.

The polymerizable monomer composition for core was poured into the above-obtained colloidal dispersion (amount of colloid: 6.3 parts) of magnesium hydroxide, the resultant mixture was stirred until droplets became stable, and 5 parts of t-butyl peroxy-2-ethylhexanoate (product of Nippon Oil & Fats Co., Ltd., trade name “PERBUTYL O”) was added to the mixture. Droplets of the polymerizable monomer composition were then formed by means of an in-line type emulsifying and dispersing machine (manufactured by Ebara Corporation, trade name “EBARA MILDER MDN303V”).

Hereinafter, the same process as in Example 1 was conducted to obtain colored resin particles having a volume average particle diameter Dv of 6.1 μm and a particle diameter distribution Dv/Dp of 1.12.

Into 100 parts of the colored resin particles thus obtained, were added 0.5 part of silica having a number average primary particle diameter of 12 nm and 2.0 parts of silica having a number average primary particle diameter of 40 nm, and the resultant mixture was mixed for 10 minutes at a rotating speed of 1,400 rpm by means of a Henschel mixer to prepare a non-magnetic one-component developer (may also be referred to as “toner”).

### Example 3

A non-magnetic one-component developer (may also be referred to as “toner”) was prepared in the same manner as in Example 2 except that 3 parts of the negatively charging charge control resin (sulfonic functional group-containing styrene/acrylic resin) in Example 2 was changed to 0.6 part of a positively charging charge control resin (quaternary ammonium group-containing styrene/acrylic resin).

### Comparative Example 1

A non-magnetic one-component developer (may also be referred to as “toner”) was prepared in the same manner as in Example 1 except that the yellow colorant was changed to C.I. Pigment Yellow 155.

### Comparative Example 2

A non-magnetic one-component developer (may also be referred to as “toner”) was prepared in the same manner as in Example 1 except that the yellow colorant was changed to C.I. Pigment Yellow 180.

### Comparative Example 3

A non-magnetic one-component developer (may also be referred to as “toner”) was prepared in the same manner as in Example 1 except that the yellow colorant was changed to C.I. Pigment Yellow 185.

The results of Examples 1 to 3 and Comparative Examples 1 to 3 are shown in Table 1.

TABLE 1

| | Example | | | Comparative Example | | |
|---|---|---|---|---|---|---|
| | 1 | 2 | 3 | 1 | 2 | 3 |
| Colorant | | | | | | |
| Kind | PY213 | PY213 | PY213 | PY155 | PY180 | PY185 |
| Amount added (parts) | 6 | 6 | 6 | 6 | 6 | 6 |
| Colored particles | | | | | | |
| Volume average | 7.4 | 6.1 | 6.5 | 7.8 | 8.5 | 8.1 |
| particle diameter (μm) | | | | | | |
| Average circularity | 0.980 | 0.975 | 0.981 | 0.970 | 0.975 | 0.975 |
| Dispersion condition of | | | | | | |
| colorant | | | | | | |
| Average particle | 40 | 67 | 59 | 52 | 130 | 69 |
| diameter (nm) | | | | | | |
| Particles of 400 nm or | 3 | 4 | 4 | 4 | 7 | 5 |
| greater (%) | | | | | | |
| Test of weathering | | | | | | |
| resistance | | | | | | |
| Initial ID | 1.40 | 1.33 | 1.39 | 1.43 | 1.36 | 1.50 |
| After-test ID | 1.26 | 1.21 | 1.27 | 0.49 | 0.54 | 0.43 |
| Percent reduction of | 10 | 10 | 9 | 66 | 60 | 71 |
| ID (%) | | | | | | |
| Environmental stability | | | | | | |
| Fog (NN environment) | 0.4 | 0.3 | 0.5 | 0.5 | 1.0 | 0.8 |
| Fog (HH environment) | 0.8 | 0.7 | 0.4 | 7.8 | 3.2 | 3.8 |

(Note)
PY213: Pigment Yellow 213
PY155: Pigment Yellow 155
PY180: Pigment Yellow 180
PY185: Pigment Yellow 185

From the results shown in Table 1, the following facts are known.

The yellow toners of Comparative Examples 1 to 3 making use of the yellow colorants of the structures not corresponding to the structural formula (1) caused fog under high-temperature and high-humidity environment, and were greatly reduced in image density in the test of weathering resistance.

On the other hand, the yellow toners of Examples 1 to 3 containing the yellow colorant of the structural formula (I) were excellent in environmental stability and exhibited high weathering resistance.

### INDUSTRIAL APPLICABILITY

The yellow toners obtained by the present invention can be used as developers in image forming apparatus of an electrophotographic system, such as copying machines, facsimiles and printers, and image forming apparatus of a toner jet system.

1. A yellow toner comprising colored resin particles containing a binder resin and a yellow colorant, wherein
the yellow colorant is a compound represented by a structural formula (1): 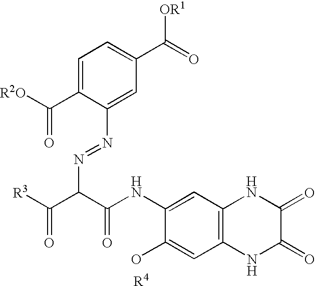
wherein R¹, R², R³ and R⁴ are, independently of one another, a hydrogen atom, an alkyl group having 1 to 12 carbon atoms, or an alkenyl group having 2 to 12 carbon atoms, and the average circularity of the colored resin particles is 0.970 to 0.995.

2. The yellow toner according to claim 1, wherein the yellow colorant is dispersed in a dispersion condition that when the sections of the colored resin particles are observed through a transmission electron microscope, the average particle diameter of the colorant is at most 80 nm, and the proportion of particles having a particle diameter of at least 400 nm is at most 5% by number.

3. The yellow toner according to claim 1, wherein the yellow colorant is a compound that R¹, R², R³ and R⁴ in the structural formula (1) are, independently of one another, an alkyl group having 1 to 3 carbon atoms.

4. The yellow toner according to claim 1, wherein the yellow colorant is a compound that R¹, R², R³ and R⁴ in the structural formula (1) are methyl groups.

5. The yellow toner according to claim 1, wherein the content of the yellow colorant is 1 to 15 parts by weight per 100 parts by weight of the binder resin.

6. The yellow toner according to claim 1, wherein the volume average particle diameter of the colored resin particles is 3 to 8 μm.

7. The yellow toner according to claim 1, wherein the average circularity of the colored resin particles is 0.975 to 0.995.

8. The yellow toner according to claim 1, wherein the average circularity of the colored resin particles is 0.975 to 0.990.

9. The yellow toner according to claim 1, wherein the colored resin particles are formed by a wet process.

10. The yellow toner according to claim 9, wherein the wet process is a suspension polymerization process.

11. The yellow toner according to claim 1, wherein the colored resin particles also contain a charge control resin.

12. The yellow toner according to claim 1, wherein the colored resin particles are colored resin particles having a core-shell structure.
